(19) United States
(12) Patent Application Publication
(10) Pub. No.: US 2015/0266193 A1
(43) Pub. Date: Sep. 24, 2015

(54) ROTARY CUTTING TOOL

(71) Applicant: Grant Bell, Santa Clara, CA (US)

(72) Inventor: Grant Bell, Santa Clara, CA (US)

(21) Appl. No.: 14/665,761

(22) Filed: Mar. 23, 2015

Related U.S. Application Data
(60) Provisional application No. 61/968,817, filed on Mar. 21, 2014.

(51) Int. Cl. B26B 25/00

(52) U.S. Cl. CPC B26B 25/005

(57) ABSTRACT

The disclosed subject matter relates to a cutting tool apparatus that may be used in food preparation and food service. The cutting tool may include a blade used for cutting. The blade may rotate about an axis. A housing may be coupled to the blade to support the blade. The blade may include channels that mate with housing channels. A handle may be coupled with the housing.

### CROSS-REFERENCE TO RELATED APPLICATION

This application claims the benefit of U.S. Provisional Patent Application Ser. No. 61/968,817, filed Mar. 21, 2014, and entitled “CUTTING TOOL/KNIFE HANDLE,” the entirety of which is incorporated herein by reference.

### TECHNICAL FIELD

The present disclosure relates to a cutting tool and more particularly, to a cutting tool having a handle.

### BACKGROUND

Rotary cutters, knives, blades and other kitchen utensils are commonly used for cutting pizza, flat breads, breads and other food items in the kitchen and food service industry.

Rotary style cutters have limitations when it comes to the depth of cut, this due to the central rotary point needed to affix the axil of the cutting disc to. The depth of cut is thus 40 to 45% of the full cutting disk diameter. The center rotary point is closer to the item being cut and thus leads to food buildup on the tool. It often comes in contact with food being cut resulting in a messy cut. The removal of the center axis point allows for 70% of the blade diameter to be used.

The Pitzo, Hubless Pizza cutter has attempted to use the hubless design. However their method of attaching the body to the blade has resulted in a decrease in he cutting depth. Less than 20% of the blade diameter may be used to make a cut.

### BRIEF SUMMARY OF THE INVENTION

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

A rotary cutting tool may cut objects, such as foodstuff in food preparation and food service. The rotary cutting tool may include a removed central rotary axis point. The blade may be attached to a guide channel housing. The blade may include a channel. The channel may be received by the guide channel housing. The guide channel housing may stabilize the blade and allow for rotation of the blade. The guide channel housing may include a low friction material. The guide channel housing may be attached to a handle. The rotary cutting tool may provide a deeper cut without the need for a large blade.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 shows a perspective view of a rotary cutting tool in accordance with various disclosed embodiments.

FIG. 2 shows bottom view of a rotary cutting tool in accordance with various disclosed embodiments.

FIG. 3 shows top view of a rotary cutting tool in accordance with various disclosed embodiments.

FIG. 4 shows left side view of a rotary cutting tool in accordance with various disclosed embodiments.

FIG. 5 shows right side view of a rotary cutting tool in accordance with various disclosed embodiments.

FIG. 6 show left side view with section view of a rotary cutting tool in accordance with various disclosed embodiments.

FIG. 7 shows exploded view & section view of a rotary cutting tool in accordance with various disclosed embodiments.

FIG. 8A shows a partial cross-section view of a blade in accordance with various disclosed embodiments.

FIG. 8B shows a partial cross-section view of a blade in accordance with various disclosed embodiments.

FIG. 8C shows a partial cross-section view of a blade in accordance with various disclosed embodiments.

FIG. 8D shows a partial cross-section view of a blade in accordance with various disclosed embodiments.

FIG. 8E shows a partial cross-section view of a blade in accordance with various disclosed embodiments.

FIG. 9 shows top exploded view of a rotary cutting tool in accordance with various disclosed embodiments.

FIG. 10 shows bottom exploded view of a rotary cutting tool in accordance with various disclosed embodiments.

FIG. 11 shows orthographic exploded view of a rotary cutting tool in accordance with various disclosed embodiments.

FIG. 12A shows a perspective side view of a portion of a rotary cutting tool in including connector pins in accordance with various disclosed embodiments.

FIG. 12B shows a back side view of a portion of a rotary cutting tool in including connector pins in accordance with various disclosed embodiments.

FIG. 12C shows a right side view of a portion of a rotary cutting tool in including connector pins in accordance with various disclosed embodiments.

FIG. 12D shows a perspective view of a portion of a rotary cutting tool and an expanded view thereof, in including connector pins in accordance with various disclosed embodiments.

### DETAILED DESCRIPTION AND BEST MODE OF IMPLEMENTATION

Reference will now be made in detail to exemplary embodiments, examples of which are illustrated in the accompanying drawings, wherein like numbered aspects refer to a common feature throughout. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality. It is further noted that while various embodiments refer to a rotary cutting tool for cutting foodstuff, various other systems may be utilized in view of embodiments described herein. For example, embodiments may be utilized in fabric cutting, clay cutting (e.g., modeling compound cutting, such as PLAY-DOH, etc.), and the like.

It is further noted that while “cutting” is generally referenced by various exemplary embodiments, the systems, apparatuses, and/or methods described herein may be utilized for non-cutting applications. For instance, a user may utilize the rotary cutting tool to form indentations, perforations, imprints, patterns, or the like. For example, a rotary cutting tool may form patterns in a stock paper for a scrap book application.

Moreover, while examples may refer to a “user” and/or actions by a user, it is noted that a user may not be required for such actions. In embodiments, actions may be performed by automated machines (e.g., machines controlled by a user and/or a processor with instructions stored in a non-transitory memory).

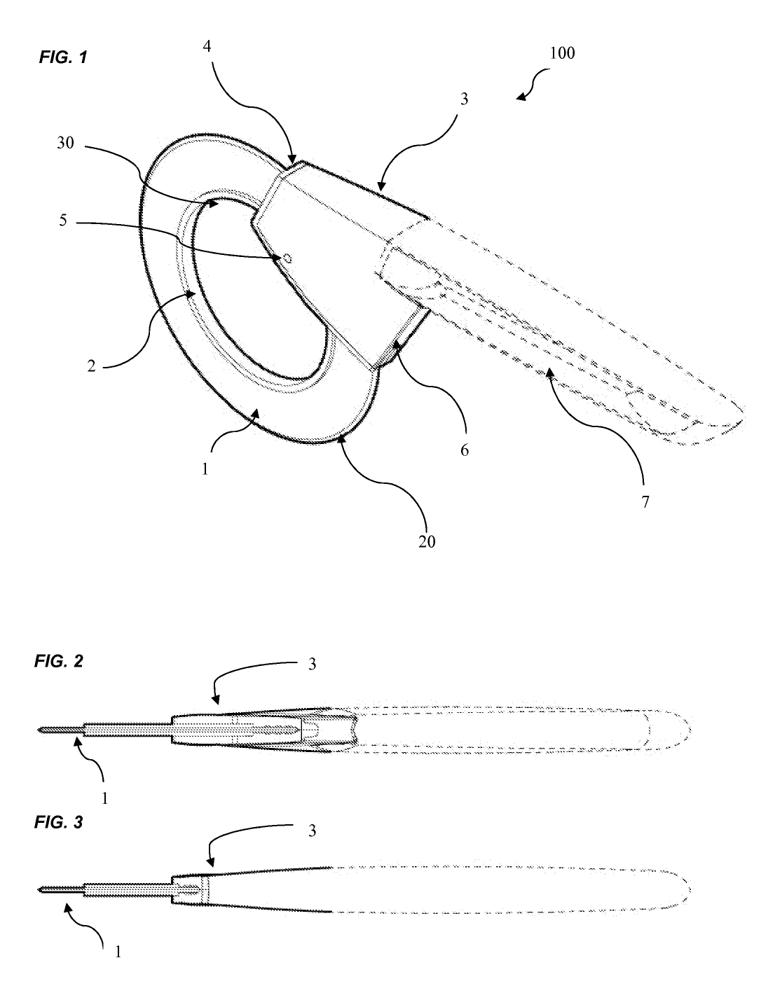

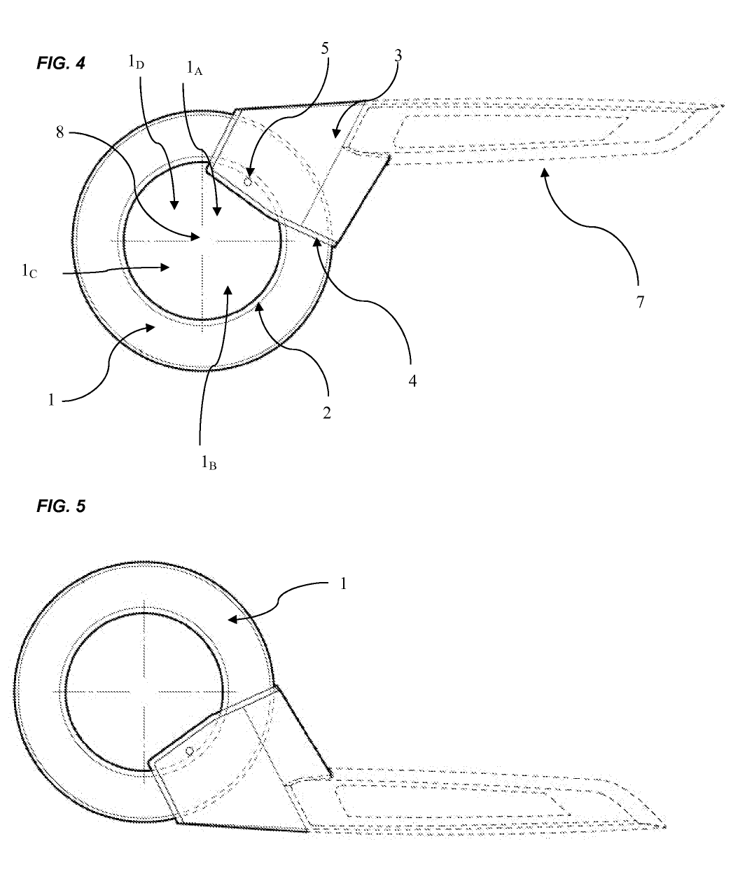

FIGS. 1-7 and 9-12D, illustrate a rotary cutting assembly or tool 100. Rotary cutting tool 100 may generally include a rotary blade or blade 1, a housing 3 comprising a guide channel housing 4, and a handle 7. It is noted that rotary cutting tool 100 may include other components not shown for sake of brevity. In another aspect, while components of rotary cutting tool 100 are described as separate components, it is noted that the components may comprise a single component. For example, handle 7 and housing 3 may comprise a single component. It is further noted that the components may comprise a portion of a larger system. In at least one embodiment, housing 3, channel housing 4, and handle 7 may each be comprised or constructed of two or more parts. For example, housing 3 (and/or channel housing 4, handle 7, etc.) may comprise two halves that may be mechanically (e.g., screwed, bolted, snapped, etc.), chemically (e.g., via an adhesive, sonic welding, etc.), or otherwise joined together. In another example, portions of housing 3 may be hingedly secured to each other.

Blade 1 may comprise a rotary cutting blade. In an embodiment, blade 1 may be generally circular or cylindrical (e.g., a ring shape, a circular frame, etc.), as shown in FIG. 1. It is noted that at least one other embodiment may include blade 1 comprising a different shaped, such as generally elliptical, irregular in shape, or the likes. Blade 1 may be monolithically formed (e.g., one piece) or may be formed of two or more attached components. For instance, blade 1 may include a channel 2 that may be monolithically formed with blade 1 and/or attached to blade 1.

It is noted that blade 1 may be comprised of one or more materials, such as plastics (e.g., food grade plastics), metals (e.g., stainless steal), rubber, wood, or the like. In at least one embodiment, blade 1 may comprise a low friction material, such as a material composed of a thermoplastic (acetal, polyacetal and polyformaldehyde) or a similar composite. In another aspect, blade 1 may include a non-stick coating disposed or deposited thereon. For instance, cutting tool 100 may be utilized in food cutting or preparing implementations. A non-stick coating may allow for decreased amounts of foodstuff sticking to blade 1 and/or clogging guide channel housing 3.

Blade 1 may include a cutting edge 20. Cutting edge 20 may be disposed along an outer perimeter of blade 1. Cutting edge 20 may include a sharpened edge (e.g., triangular shaped, etc.), a rounded edge, and/or a flat edge. In another aspect, cutting edge 20 may include a design (e.g., curved line, etc.) that may be imprinted on or in an object (e.g., paper, modeling compounded, etc.).

In an embodiment, blade 1 may include channel 2. Channel 2 may include at least one flange or groove. For instance, channel 2 may include a T-shaped flange, an L-shaped flange, a single groove, a first and a second groove, and/or the like. It is noted that blade 1 may not include a flange or groove and may be coupled to housing 3 via another means, such as one or more pins.

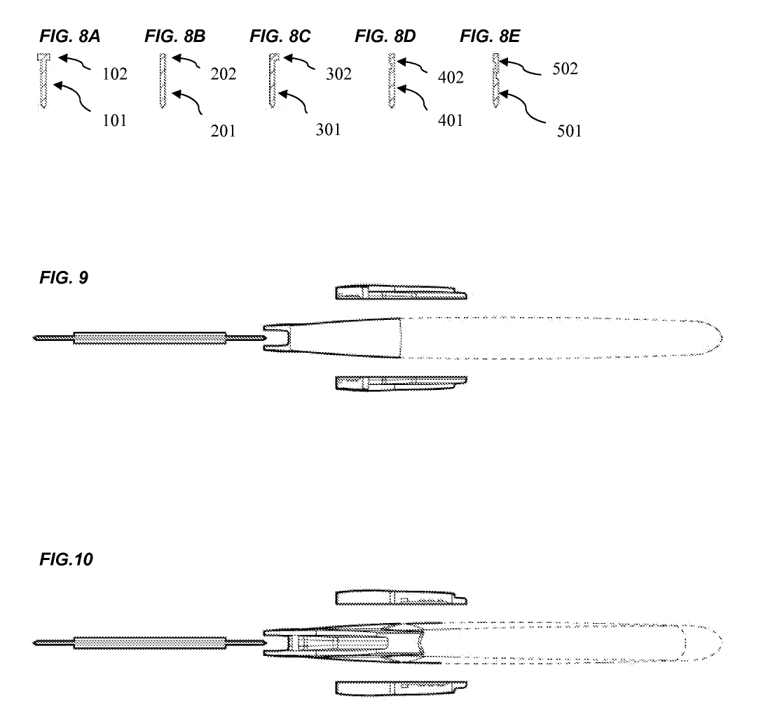

Turning to FIGS. 8A, 8B, 8C, 8D, and 8E, with reference to FIG. 1, there are partial cross-sectional views of exemplary embodiments of a blade (e.g., blade 1). FIG. 8A depicts blade 101 comprising channel 102 in a T-shape flange configuration. FIG. 8B depicts blade 201 comprising channel 202 in an a flat configuration. FIG. 8C depicts blade 301 comprising channel 302 in an L-shape flange configuration. It is noted that L-shape may face either direction. FIG. 8D depicts blade 401 comprising channel 402 in a groove configuration. FIG. 8E depicts blade 501 comprising channel 502 in a multiple groove configuration. It is noted that various other channel configurations are considered within the scope and spirit of this disclosure. For instance, a blade may include both grooves and flanges.

In an embodiment, blade 1 may include a central rotary axis point 8 having material substantially removed therefrom, as depicted in FIG. 1. For instance, blade 1 may include an inner perimeter 30 that may define an inner circumference (e.g., if circular) and/or inner ring surface of blade 1. Inner perimeter 30 may include channel 2 disposed thereon (e.g., FIG. 8A, 8C, etc.). In another example, channel 2 may be disposed proximal to inner perimeter 30 (e.g., FIG. 8D, 8E, etc.). In another aspect, blade 1 may include a different number of channels. For instance, blade 1 may include a first flange channel disposed at a first position and a second flange channel disposed at a second position.

Blade 1 may be coupled or attached to housing 3. Housing 3 may be monolithically formed or formed of separate components attached or coupled together. In an embodiment, housing 3 may be off center when cutting tool 100 is used to cut an object. In another aspect, housing 3 may cover or coupled to a portion of blade 1 at a given time, such that another portion of blade 1 is exposed. For example, housing 3 may cover about half or blade 1, less than half or blade 1, less than a quarter of blade 1, or the like.

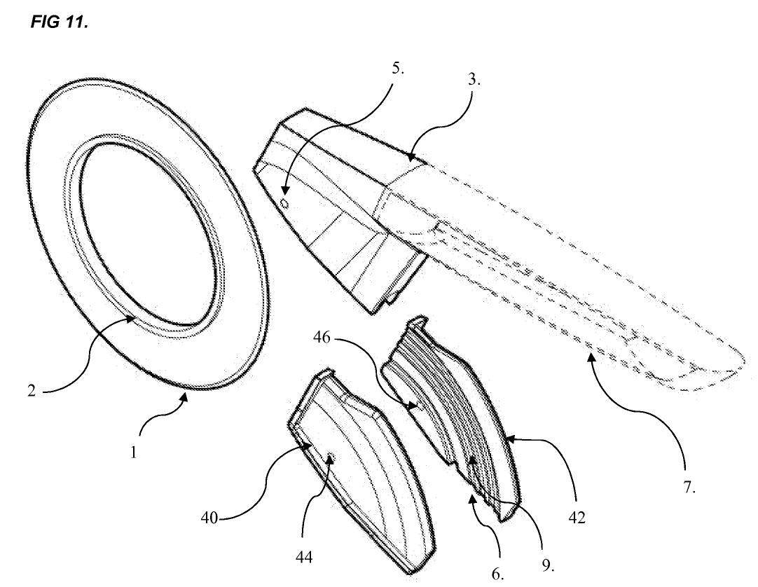

As depicted in FIG. 11, housing 3 may be coupled to guide body housing 4. Guide body housing 4 may include a first body 40 and a second body 42. First body 40 and second body 42 may be attached (e.g., removably or irremovably) via a mechanical coupling, chemical coupling, magnetic coupling, or the like. In an aspect, guide body housing 4 may be coupled to housing 3, such as via a pin, rivet, screw, bolt, latch, or the like. In an aspect, a pin may be inserted through apertures 44 and 42.

As described above, at least a portion of housing 3 may be comprised of a low friction material, such as a material comprising thermoplastic (acetal, polyacetal and polyformaldehyde) or a similar composite. For instance, housing 3 may include a blade guide 6. All or a portion of the blade guide 6 may comprise a low friction material, while a main body of the housing 3 may comprise a different material In another aspect, housing 3 may comprise a material coated with a low friction or non-stick compound and/or layer.

Blade guide 6 may include blade guide channels 9. Blade guide channels 9 may include appropriate grooves, flanges, or other formations that may couple and/or support the blade 1. For example, blade guide channels 9 may appropriately shaped based on the configuration of a channel (e.g., channel 2, 102, 202, etc.). In another aspect, housing 3 may include and/or may receive a support member 5. Support member 5 may include a pin or the like. It is noted that support member 5 may comprise one or materials described herein. For instance, support member 5 may comprise a low friction material. Support member 5 may support blade 1, such as at inner surface 30. In another aspect, support member 5 may be configured to receive and/or be received by channel 2.

In embodiments, support member 5 may be monolithically formed with housing 3 or may be separately formed and attached (e.g., removably or irremovably) to housing 3. For example, housing 3 may include apertures 44 and 46. Support member 5 may include a pin, bolt, or screw that may be inserted into aperture 44 and/or 46. It is noted that housing 3 may include a different number of support members and/or apertures.

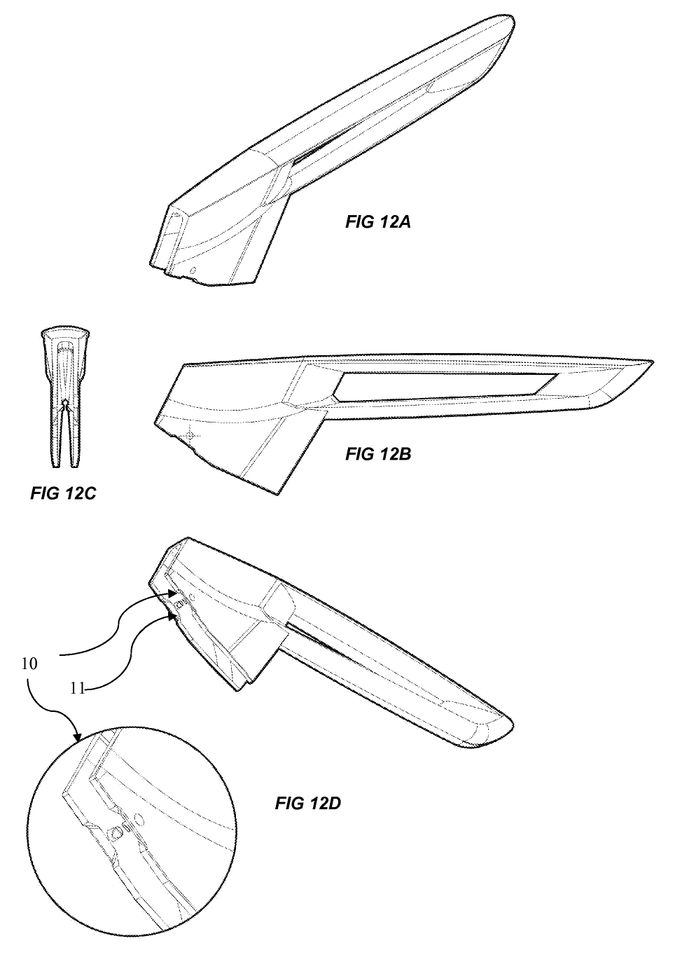

As depicted in FIG. 12D, housing 3 may include one or more pins 10. Pins 10 may be substantially coaxial. In another aspect, a first pin and a second pin may support inner perimeter 30 of blade 1. In at least one embodiment, housing 3 may include a plastic pin release 11. For example, release 11 may allow a user to release blade 1 from support member 5.

Housing 3 may be coupled with handle 7. As noted herein, handle 7 may be formed of one or more pieces and may comprise one or more materials. In an aspect, handle 7 may include an ergonomic shape, grip, or the like that may increase comfort and/or usability of the cutting tool 100. In at least one embodiment, cutting tool 100 may not include a handle 7. For example, a user may hold housing 3 during a cutting operation.

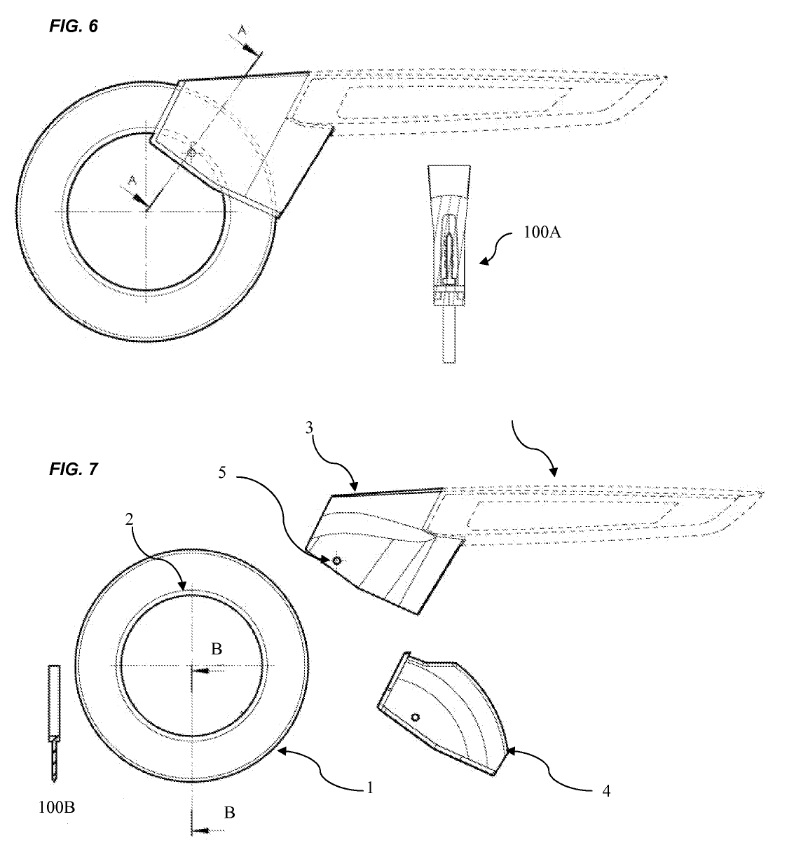

As depicted in FIG. 6, cross-section 100A depicts an alignment of housing 6 and blade 1. As depicted, when handle 7 is substantially parallel to a ground plane, housing 6 is offset with central axis point 8 of blade 1. In another aspect, about three quarters and/or substantially more than three quarters of blade 1 may be exposed. In another aspect, blade 1 may be include four quadrants 1_{A}, 1_{B}, 1_{C}, and 1_{D}. Quadrants 1_{B}-1_{D} may be substantially not covered or exposed. Quadrant 1_{A} may be substantially covered. As described, this may allow housing 6 to be offset with respect to blade 1.

In an embodiment, a user may hold handle 7 and bring blade 1 into contact with a foodstuff, such as a pizza. Housing 3 may be off center with a central axis point 8 and a ground plane, when handle 7 is not perpendicular with a ground plane. In an example, the blade 1 may freely rotate with the need for an axil. For instance, a bore of the housing may slideably receives the blade relative to a center plane.

Various aspects disclosed herein may allow for a deeper cutting in a material than traditional rotary cutting tools. In another aspect, described embodiments may decrease an overall weight, reduce binding (e.g., buildup of material/foodstuff), or the likes. It is noted that various other advantages presented by this disclose may be apparent.

As described herein, the central rotary axis point 8 may have material substantially removed. Removal of the material may allow for a deeper cut without the need for a larger blade. In another aspect, removal of the material may allow for a reduced weight with respect to a blade not having material removed.

However, in at least embodiment, blade 1 may be a disc shape. For instance, blade 1 may include central rotary axis point 8 substantially comprising a material. The blade 1 may be coupled or secured by one or more channels (e.g., channel 2) coupled to housing 3. In an example, cutting tool 100 may not include a pin extending through housing 3, such that blade 1 may be connected thereto. For instance, a channel (e.g., flange, groove, etc.) may be positioned along any appropriate portion of a surface of blade 1.

Although the present embodiments have been illustrated in the accompanying drawings and described in the foregoing detailed description, it is to be understood that the blending system is not to be limited to just the embodiments disclosed, but that the blending system described herein is capable of numerous rearrangements, modifications and substitutions.

I claim:

1. A cutting tool assembly comprising:
a rotary blade comprising a channel and a cutting edge; and
a housing coupled to the blade and comprising a blade guide configured to mate with the channel, wherein the housing covers less than half of the blade.

2. The cutting tool assembly of claim 1, wherein an inner portion of the rotary blade is substantially removed of material, such that the rotary blade represents a ring-like shape.

3. The cutting tool assembly of claim 1, wherein the housing comprises a low friction material.

4. The cutting tool assembly of claim 4, wherein the low friction material comprises a thermoplastic composite material.

5. The cutting tool assembly of claim 1, wherein the housing further comprises a blade guide configured to receive the rotary blade.

6. The cutting tool assembly of claim 5, wherein the blade guide comprises a non-stick layer.

7. The cutting tool assembly of claim 1, further comprising a handle extending from the housing.

8. The cutting tool assembly of claim 1, wherein the housing comprises a first body and a second body.

9. The cutting tool assembly of claim 1, further comprising a support member configured to support at least a portion of the rotary blade.

10. The cutting tool assembly of claim 9, wherein the support member comprises at least one of a pin, screw, or bolt.

11. A rotary cutting apparatus for cutting foodstuff, comprising:
a housing comprising a guide channel and a low-friction material;
a rotary blade coupled to the housing and configured to rotate about a central axis, wherein the blade comprises a channel that is configured to be received by the guide channel; and
wherein the housing is offset from a central axis of the rotary blade.

12. The rotary cutting apparatus of claim 11, wherein the central axis of the rotary blade is substantially removed of material.

13. The rotary cutting apparatus of claim 11, wherein the rotary blade comprise a first quadrant, a second quadrant, a third quadrant and a fourth quadrant, and wherein the housing substantially covers the first quadrant.

14. The rotary cutting apparatus of claim 10, wherein the second quadrant, the third quadrant and the fourth quadrant are substantially exposed.

15. The rotary cutting apparatus of claim 11, wherein the housing comprises a thermoplastic composite material.

16. The rotary cutting apparatus of claim 11, further comprising a handle extending from the housing.

17. The rotary cutting apparatus of claim 16, wherein the housing and the handle comprise the same material.

18. A rotary cutting device comprising:
a blade comprising:
a center that is substantially removed of material to form a ring shape;
at least one channel disposed proximal to an inner perimeter of the ring shape; and
a cutting edge disposed along an outer perimeter of the ring shape;
a housing comprising:
a guide channel configured to receive the at least one channel; and
a support member configured to support the inner perimeter; and
a handle extending from the housing.

19. The rotary cutting device of claim 18, wherein the blade rotates about the center.

20. The rotary cutting device of claim 18, wherein the housing is offset from the center of the blade at least when the handle is substantially parallel with a ground plane.
